(19) United States
(12) Patent Application Publication
(10) Pub. No.: US 2014/0077754 A1
(43) Pub. Date: Mar. 20, 2014

(54) System and Method For Scheduling Lithium Ion Battery Charging

(71) Applicant: CHARGER COACH LLC, Hampton, NH (US)

(72) Inventors: Steven D. Carmichael, Raymond, NH (US); Robert F. Skaff, JR., Hampton, NH (US)

(73) Assignee: Charger Coach LLC, Hampton, NH (US)

(21) Appl. No.: 13/622,099

(22) Filed: Sep. 18, 2012

(51) Int. Cl. H02J 7/00

(52) U.S. Cl. 320/107; 320/162; 320/157

(57) ABSTRACT

A battery charging system and method for schedule based charging to pre-charge a battery to an interim voltage level for a first duration of time and applies a finishing to a maximum voltage level at a second time shortly preceding use of the battery. The finishing charge may be initiated based on a schedule or may by a manual actuator.

### FIELD OF THE INVENTION

The present invention relates to energy storage, and more particularly, is related to charging lithium ion batteries.

### BACKGROUND OF THE INVENTION

In general, many battery systems in mobile electronic devices use high density capacity rechargeable batteries. The longevity of the batteries is significantly affected by battery charging patterns. One major factor of battery longevity is the amount of time a battery rests at a maximum safe voltage, or full charge, which may stress the battery, negatively impacting its longevity. Many users of such battery systems do not have the knowledge, tools, or desire to manage battery stress. As a result, some consumers become dissatisfied with products containing these batteries, and the manufacturers of these products provide solutions for replacing batteries that fail prematurely. Unfortunately, battery replacement is often an expensive out of warranty event that requires the device to be taken out of service, transported to the factory and back to the consumer. In addition, designing a mobile electronic device to facilitate battery replacement may add to the size, weight and cost of the device.

Lithium ion battery chargers are generally based on a lithium ion charge cycle (LICC). According to accepted practices, charging a lithium ion battery initially involves a constant current charge. As the battery is charged using LICC, the impedance (R) rises. According to Ohm's law, V=IR, where V is voltage, I is current, the voltage rises with this constant current. A target voltage may vary based on the goal of the charge. When the target voltage is reached, the charge cycle changes from constant current to constant voltage. During the constant voltage charge portion of the LICC, the impedance continues to rise. Since I=V/R, as the impedance rises, the current drops. Under a standard LICC, when the current flowing to the battery drops to 1/20 C, the battery is then considered charged at the constant voltage set.

Charging a lithium ion battery to a set voltage is a typical practice with the voltage never exceeding a maximum voltage for the cell, or a slightly lower voltage the manufacturer suggests for the battery may extend the longevity of the battery. Longevity charging involves first charging it to an interim (optimum) voltage and saturating the battery at an optimum voltage. Saturation charging may be performed for several reasons. First, a battery charged to the optimum voltage has a substantial amount of capacity in the event it needs to be used immediately. Second, the battery can be fully charged quickly to realize its full potential immediately before its peak time of use. Third, a battery charged at the interim (optimum) level will not fatigue the battery while charging the battery to the full level will fatigue the battery and result in overall reduced run time much faster than if the longevity charging techniques are employed.

A typical prior art smart lithium ion battery charger has a charge cycle as shown by the plots of FIG. 1. A plot of time v. voltage 10 and a plot of time v. current 20 are shown. When a battery is connected to the battery charger at time t=0 hours, the battery charger applies a constant current to the battery and detects when the voltage level of the battery has risen to a predetermined maximum voltage level 50, at time t=1.5 hours 30. The charger applies constant current to the battery until the battery voltage reaches a maximum voltage level 50 for the battery. The charge cycle enters the constant voltage mode. With the impedance rising, the battery current gradually reduces until the battery is fully saturated at time t=3 hours, when the current is turned off. If the battery remains at maximum voltage until a removal time 40 when the battery is removed from the charger, for example, at time t=9 hours, then the battery has experienced 7.5 hours of voltage stress.

Some chargers have a storage mode to avoid such voltage stress on a battery. When operating under storage mode, instead of charging to a maximum voltage, the battery charges to a pre-determined level other than the maximum to help increase the life of the battery. This pre-determined level is called the optimum voltage. While this avoids stressing the battery, with such a charger the user can never take advantage of the full capacity of the battery when it is needed.

In another example, a device with one or more built in batteries that are difficult or expensive to replace may only charge and drain the battery to optimum voltage levels, avoiding a maximum voltage and minimum voltage by substantial margins. While this may extend the longevity of the battery, it does not provide the user access to the device when fully charged to a maximum voltage, effectively decreasing the total capacity of the device. Therefore, there is a need in the art to address the above shortcomings.

### SUMMARY OF THE INVENTION

Embodiments of the present invention provide a system and method for scheduling lithium ion battery charging. Briefly described, the present invention is directed to a method for charging a battery with a battery charger, including the steps of applying a constant current charge to the battery, detecting a voltage level of the battery, discontinuing applying the constant current to the battery when the voltage level substantially reaches a first threshold voltage, automatically resuming the constant current charge to the battery, and discontinuing applying the constant current charge to the battery when the voltage level substantially reaches a second threshold voltage. A step may include upon the discontinuation of applying the constant current charge, applying a constant voltage charge to the battery. Further steps may include detecting a battery saturation level, and discontinuing the application of the constant voltage charge.

Briefly described, in architecture, a second aspect of the present invention is directed to a system for charging a battery including a voltage detector configured to detect a voltage level of the battery, a battery charger configured to charge the battery, wherein the battery charger selectably charges the battery in one of the group consisting of constant current mode and constant voltage mode, and a controller including a computer logic circuit in communication with the voltage detector. The controller is configured to control the battery charger according to the steps of activating the battery charger in constant current mode, receiving a voltage level of the battery from the voltage detector, deactivating the constant current mode when the voltage level substantially reaches a first threshold voltage, automatically resuming the constant current mode, and deactivating the constant current mode when the voltage level substantially reaches a second threshold voltage.

A third aspect of the present invention is directed to a computer readable memory configured to store non-transient instructions for controlling a battery charger system, including the steps of applying a constant current to the battery, detecting a voltage level of the battery, discontinuing applying the constant current to the battery when the voltage level substantially reaches a first threshold voltage, automatically resuming the constant current to the battery, and discontinuing applying the constant current to the battery when the voltage level substantially reaches a second threshold voltage.

Other systems, methods and features of the present invention will be or become apparent to one having ordinary skill in the art upon examining the following drawings and detailed description. It is intended that all such additional systems, methods, and features be included in this description, be within the scope of the present invention and protected by the accompanying claims.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principals of the invention.

FIG. 1 is a plot of voltage v. time and current v. time for a prior art charging system.

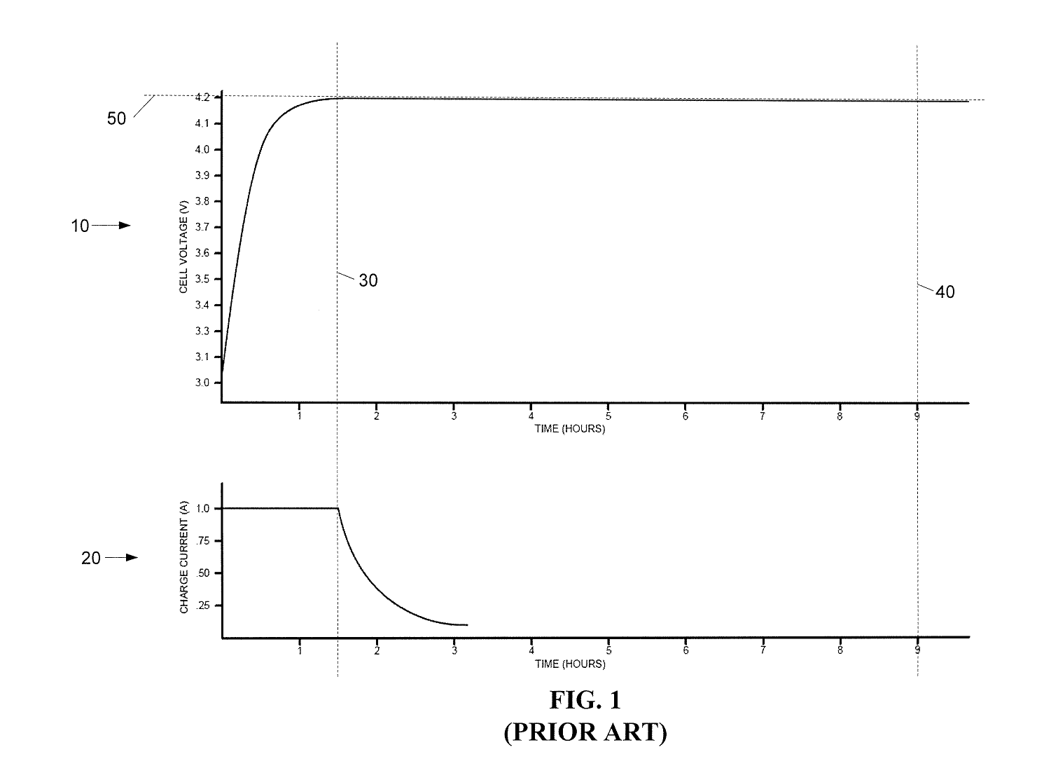

FIG. 2 is a plot of voltage v. time overlaying a current v. time plot for a first embodiment of a battery charging system.

FIG. 3 is a first plot of voltage v. time and a second plot of current v. time for the first embodiment of the battery charging system of FIG. 2.

FIG. 4 is a flowchart of an exemplary method for charging a battery.

FIG. 5 is a schematic diagram illustrating an example of a controller for executing functionality of the present invention.

FIG. 6 is a schematic diagram illustrating an example of a battery charging system of the present invention.

### DETAILED DESCRIPTION

Reference will now be made in detail to embodiments of the present invention, examples of which are illustrated in the accompanying drawings. Wherever possible, the same reference numbers are used in the drawings and the description to refer to the same or like parts.

As noted above, there are scenarios where prior art LICCs results in less than optimal battery performance for a device. A user, for example, a professional carpenter, may use a lithium ion battery powered tool daily. For a typical eight hour work day, the user starts the day with a fully charged battery. The device is used throughout the day and the battery may or may not be recharged during that time. At the end of the day, the user places the battery on charge and fatigue may occur between the time the battery is fully charged, and the beginning of the next day when the device is used again.

With a longevity charging mode, the user starts the day with a fully charged battery, the device is used throughout the day and the battery may or may not be recharged during that time. If the battery is charged during the day, the battery is only charged to the optimum voltage to avoid fatigue. At the end of the day, the user places the battery on charge. The battery is again put on charge to the optimum voltage and shortly before the day starts the charger completes a typical charge cycle ensuring the battery is fully charged for the day. Therefore, longevity charging mode may reduce the amount of time a battery is charged to its stressed level by 50-90%. Prior art longevity charging techniques generally remain within limits of safe charging of the battery. If for any reason a battery is below the minimum voltage, a prior art longevity charging system generally follows an acceptable procedure for charging a very low (or dead) battery.

Charging Longevity System

Under the first embodiment, a battery charging system uses scheduled based charging to pre-charge a battery to an interim voltage level and finishes the charge shortly preceding use. The finishing charge may be based on a schedule. Scheduled based charging affords the device to take full advantage of the capacity of the battery without spending large amounts of time at maximum voltage causing stress on the battery.

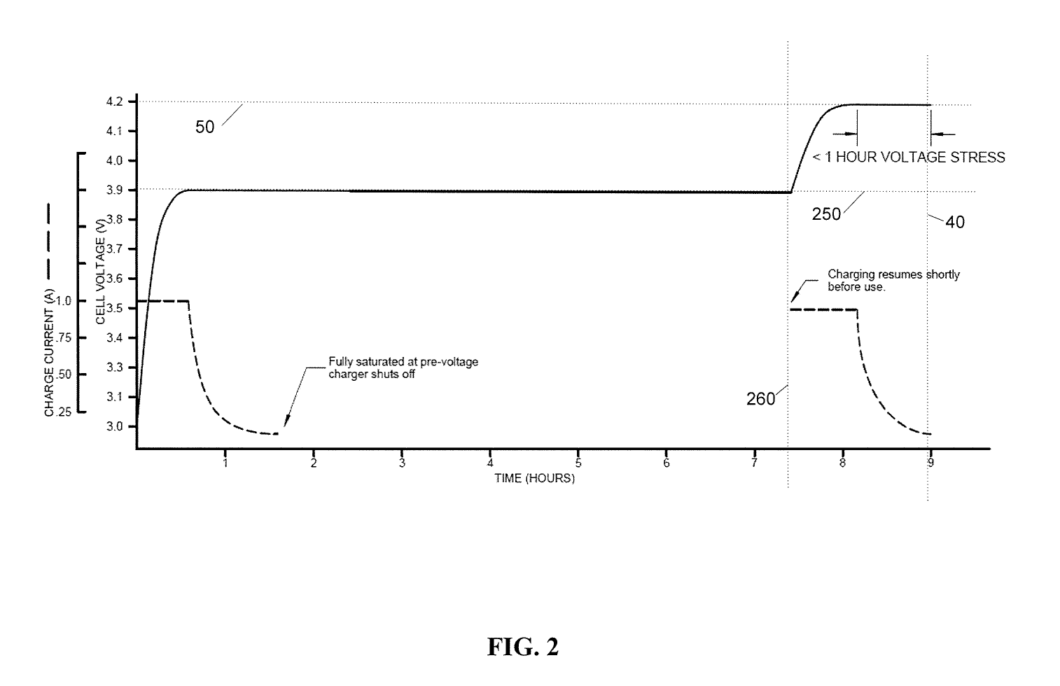

FIG. 2 shows plots of voltage v. time and current v. time for an exemplary first embodiment of a charging system. The voltage plot is shown as a solid line, while the current plot is shown as a dashed line. Under the first embodiment, the charging system charges the battery to an optimum voltage 250 and holds until a schedule indicates it is time to charge to maximum voltage 50. The optimum voltage 250 may be predetermined before charging begins, and may be different for different batteries. A constant current charge is applied to the battery at time t=0 until the battery voltage reaches the optimum voltage 250 and then a constant voltage charge is applied until the current drops to 1/20 of the amp hour (aH) rating of the battery cell. Charge time is substantially dependent on the charge current chosen by the charger manufacturer (using guidance from the battery supplier) and the overall capacity of the battery cell(s). Instead of a set voltage during the initial portion of the charge cycle being the maximum voltage acceptable for the cell, for example, 4.2V, the target voltage threshold is set to an optimum voltage 250. For example, the optimum voltage 250 may be set to 80% of voltage range plus the minimum voltage. In the case of a cell having a maximum voltage of 4.2V and minimum voltage of 2.9V, the optimum voltage would therefore be set at 80% of (4.2V−2.9V)+2.9V, or 3.94V.

The right side of FIG. 2 shows charging the battery from optimum voltage 250 to maximum voltage 50. The charge pattern may be substantially similar to the pattern of charging a battery from a low charge state. Once the battery reaches the maximum voltage 50, the charge circuit converts from a constant current charge to a constant voltage charge until the current flow drops to a shut off point, for example, one twentieth of the maximum capacity rating for the battery. The battery remains in the charger until the removal time 40. It should be noted that the charge time of a fully saturated battery from the optimum voltage 250 (saturated) to the maximum voltage 50 (saturated) is generally significantly less than charging a battery in an unsaturated state at any operating voltage between a minimum voltage and the optimum voltage 250. The battery charger system operates within the bounds of recognized safe charging schemes. If the battery voltage is below the minimum voltage, the charger may operate as a conventional smart charger and only provide the appropriate low voltage schemes until the voltage reaches the minimum voltage. Of course, safety schemes used in prior chargers may be used to override any and all features of the charging system.

It is generally difficult for operators of battery operated devices to manage the battery voltage and saturation levels, and it is often impractical to reduce the overall capacity of the battery to remain well within the limits of minimum voltage and maximum voltage. It is desirable to minimize the time the battery spends at maximum voltage while still utilizing the maximum capacity of the battery during peak usage time.

Under the first embodiment, the charging system includes a scheduler to better manage the battery charging cycle in coordination with a use schedule of the battery powered device. For example, in circumstances where the user operates the device heavily during certain hours (7 am-3 pm for example), the charger may be scheduled to operate as follows. The charger provides a constant current charge until the battery voltage reaches the predetermined optimum voltage 250, then holds the battery voltage substantially at the optimum voltage 250, until such time 260 it is determined to start charging the battery to maximum voltage 50. The time 260 at which the charge to maximum voltage 50 begins may generally be determined by the anticipated time the battery will be used (use start time), and the amount of time required to charge the battery from the optimum voltage 250 to the maximum voltage 50. This duration is called the top off time. In general, the charger will begin the top off charge at a time determined by

top off charge start time=use start time−top off time (Eq. 2)

Therefore, at the top off charge start time, the charger will charge the battery to the maximum voltage. For example, if the top off time is two hours, and the use start time is 7:00 am, the top off charge start time will be 5:00 am. If the battery is returned to the charger after the use start time, but before the next top off charge start time, the battery is only charged to the optimum voltage and held at the optimum voltage until the next top off charge start time.

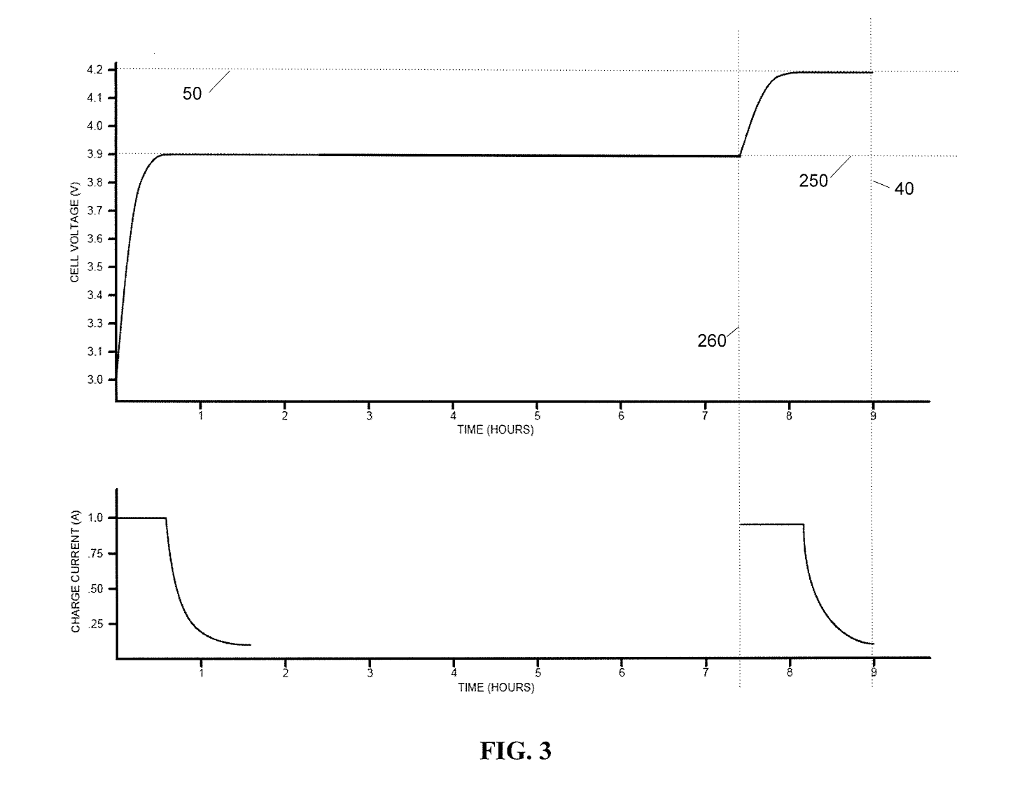

FIG. 3 shows separate plots of voltage v. time and current v. time for the exemplary first embodiment of a charging system.

Override Feature

While the charging schedule described above provides a fully charged battery powered device at previously scheduled times, there may be other occasions when it is desirable to bring the battery to full charge, for example, an unscheduled occasion. Therefore, the charging system may have an override feature that causes the charger to bring the battery to full charge at maximum voltage 50 upon activation. A first example of an override feature may be a physical full charge actuator, for example, a button or switch located on the charger, which causes the charger to begin charging the battery to full charge regardless of the present voltage detected for the battery.

A second example of an override feature is an actuator mechanism, such as a button, that puts the battery charging system in occasional/vacation mode, where the charger is limited to not charging the battery above the optimum voltage 250. When in occasional/vacation mode, the battery charging system operates substantially similarly to a prior art battery charger in storage mode, as described earlier.

For example, assuming the shift worker of the earlier example puts the portable device on charge only at the end of the shift. In this case the battery has avoided the maximum voltage 50 charge condition for 12 hours longer than if a traditional method was used. If the user charges the device during the day, the 12 hour window becomes longer. In the event the operator knows he will need as much charge as possible at midday, he may use the full charge override button midday.

The system may be configured to behave differently during different time periods. For example, a configuration may be set up to determine whether to charge to maximum voltage 50 based upon both the time of day and the day of week. The charger may be configured such that the charger charges to full charge on weekdays (Monday-Friday), but not charging above optimum voltage 250 on the weekend (Saturday-Sunday). Of course, other schedules may be similarly configured.

Learning Mode

The system may be configured to alter its schedule based on previously detected events and conditions, for example, times when a battery is attached to the charger, the detected voltage level at the time the battery is attached to the charger, the times/dates when an override feature is activated. The system may study the usage of the battery and percentage of total charge remaining when the battery is attached to the charger. In the event the battery does not use more than a specific percentage of the battery for a pre-determined number of days, the charger may automatically override the start day parameter and not allow the charger to charge beyond the optimum voltage without the use of the override button. Once the battery is drained below a specific threshold level, the system may reset learning mode, resorting back to the alternative timing scheme until it has revalidated the limited use of the battery again forcing it to never charge above optimum voltage. The full charge override button may force the battery to charge to maximum voltage, but once the battery voltage falls below the optimum voltage level, only charge the battery to optimum voltage until the learned trend is broken or the override button (one time override) is pressed. For example, if the charger detects minimal usage of the device, the charger may configure itself for occasional/vacation mode.

Method

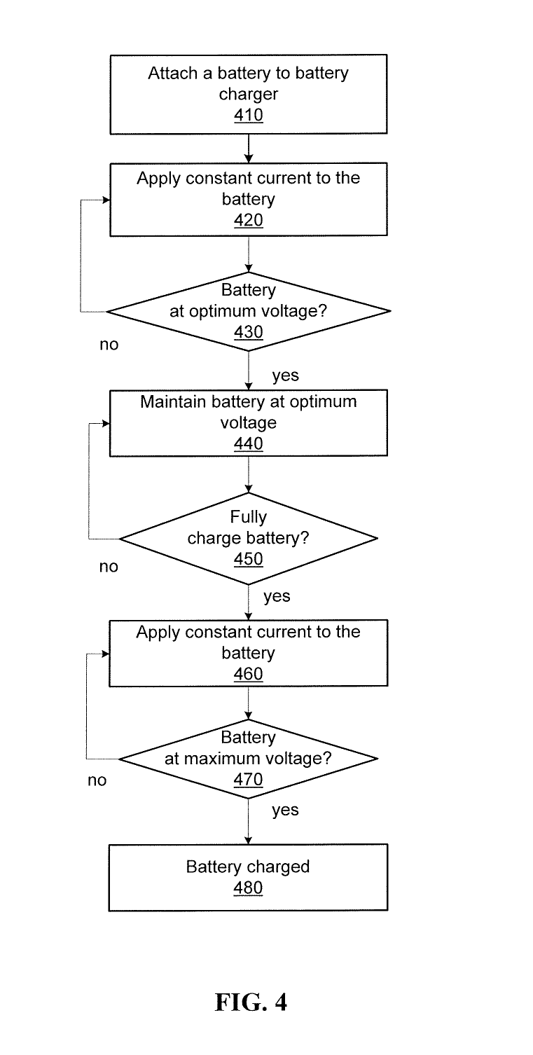

FIG. 4 shows a first exemplary embodiment of a method for charging a battery. It should be noted that any process descriptions or blocks in flow charts should be understood as representing modules, segments, portions of code, or steps that include one or more instructions for implementing specific logical functions in the process, and alternative implementations are included within the scope of the present invention in which functions may be executed out of order from that shown or discussed, including substantially concurrently or in reverse order, depending on the functionality involved, as would be understood by those reasonably skilled in the art of the present invention.

As shown by block 410, a battery is attached to a battery charger of the present invention. It should be noted that the battery charger may be integrated into a battery charged device, and the step of attaching a battery to a battery charger may be, for example, attaching an external power supply to the battery powered device. Alternatively, the battery may be removed from a battery powered device and attached to an external battery charger, for example, by inserting the battery into a battery receiving socket configured so the battery terminals are electrically connected to the charger, or the battery terminals may be electrically attached to the battery charger using, for example, lead wires and clips.

A constant current is applied to the battery, as shown by block 420. The battery charger may automatically apply constant current to the battery upon sensing attachment of the battery, or the battery charger may apply constant current based on being actuated by a switch or button, or according to a schedule. The battery charger senses the voltage level of the battery, and continues to apply a constant current charge to the battery until the battery has been charged to an optimum voltage as shown by block 430. The optimum voltage may be a predetermined voltage level specific to a battery or a device containing a battery, and may be different for different batteries attached to the charger. When the battery has reached the optimum voltage level, the current charge may be gradually reduced until the battery reaches optimum voltage level saturation.

The battery is maintained at or near the optimum voltage, as shown by block 440. For example, the battery charger may apply no charge to the battery until it senses the battery has below a hold voltage threshold, and then apply a constant current charge again until the battery is charged to the optimum voltage again. This process may repeat indefinitely until a final charge is desired, as shown in block 450. The final charge stage may begin automatically at a scheduled time, by a manual actuator such as a button or switch, or by other means. A constant current charge is applied to the battery, as shown by block 460. When the battery is charged to a maximum voltage, as shown by block 470, the current charge may be gradually reduced until the battery reaches maximum voltage level saturation, leaving the battery fully charged, as shown by block 480. At this point, the battery may be removed from the charger for use. If the battery remains in the charger, the battery may be held at maximum voltage, or may be allowed to discharge to a lower level, such as the optimum voltage, in order to reduce stress on the battery that may occur when the battery is fully charged. Alternatively, the battery charge cycle may be considered complete at the moment the battery is saturated at maximum voltage, with no further charging until the battery has been detached and re-attached.

System

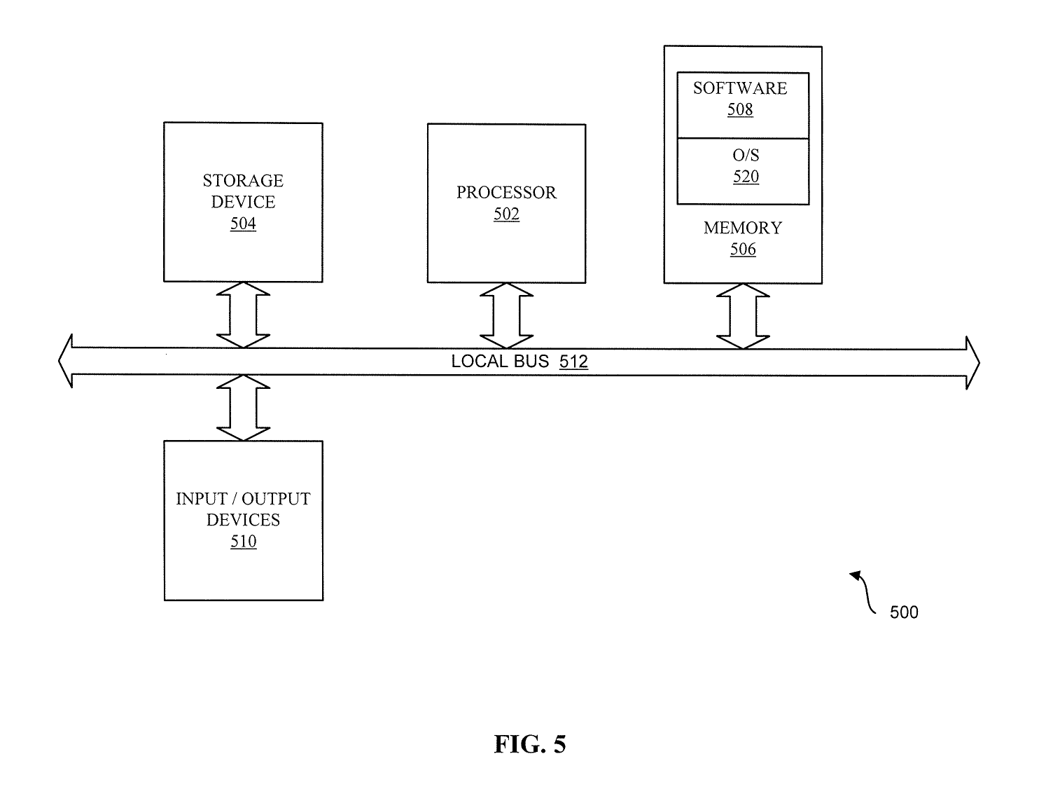

As previously mentioned, the present system for executing the functionality described in detail above may be a computer controlled controller 500, an example of which is shown in the schematic diagram of FIG. 5. The controller 500 contains a processor 502, a storage device 504, a memory 506 having software 508 stored therein that defines the abovementioned functionality, input and output (I/O) devices 510 (or peripherals), and a local bus, or local interface 512 allowing for communication within the controller 500. The local interface 512 can be, for example but not limited to, one or more buses or other wired or wireless connections, as is known in the art. The local interface 512 may have additional elements, which are omitted for simplicity, such as controllers, buffers (caches), drivers, repeaters, and receivers, to enable communications. Further, the local interface 512 may include address, control, and/or data connections to enable appropriate communications among the aforementioned components.

The processor 502 is a hardware device for executing software, particularly that stored in the memory 506. The processor 502 can be any custom made or commercially available single core or multi-core processor, a central processing unit (CPU), an auxiliary processor among several processors associated with the controller 500, a semiconductor based microprocessor (in the form of a microchip or chip set), a macroprocessor, or generally any device for executing software instructions.

The memory 506 can include any one or combination of volatile memory elements (e.g., random access memory (RAM, such as DRAM, SRAM, SDRAM, etc.)) and nonvolatile memory elements (e.g., ROM, hard drive, tape, CDROM, etc.). Moreover, the memory 506 may incorporate electronic, magnetic, optical, and/or other types of storage media. Note that the memory 506 can have a distributed architecture, where various components are situated remotely from one another, but can be accessed by the processor 502.

The software 508 defines functionality performed by the controller 500, in accordance with the present invention. The software 508 in the memory 506 may include one or more separate programs, each of which contains an ordered listing of executable instructions for implementing logical functions of the controller 500, as described below. The memory 506 may contain an operating system (O/S) 520. The operating system essentially controls the execution of programs within the controller 500 and provides scheduling, input-output control, file and data management, memory management, and communication control and related services.

The I/O devices 510 may include input devices, for example but not limited to, one or more actuators, a keyboard, mouse, scanner, microphone, etc. Furthermore, the I/O devices 510 may also include output devices, for example but not limited to, a printer, display, etc. Finally, the I/O devices 510 may further include devices that communicate via both inputs and outputs, for instance but not limited to, a modulator/demodulator (modem; for accessing another device, system, or network), a radio frequency (RF) or other transceiver, a telephonic interface, a bridge, a router, or other device.

When the controller 500 is in operation, the processor 502 is configured to execute the software 508 stored within the memory 506, to communicate data to and from the memory 506, and to generally control operations of the controller 500 pursuant to the software 508, as explained above.

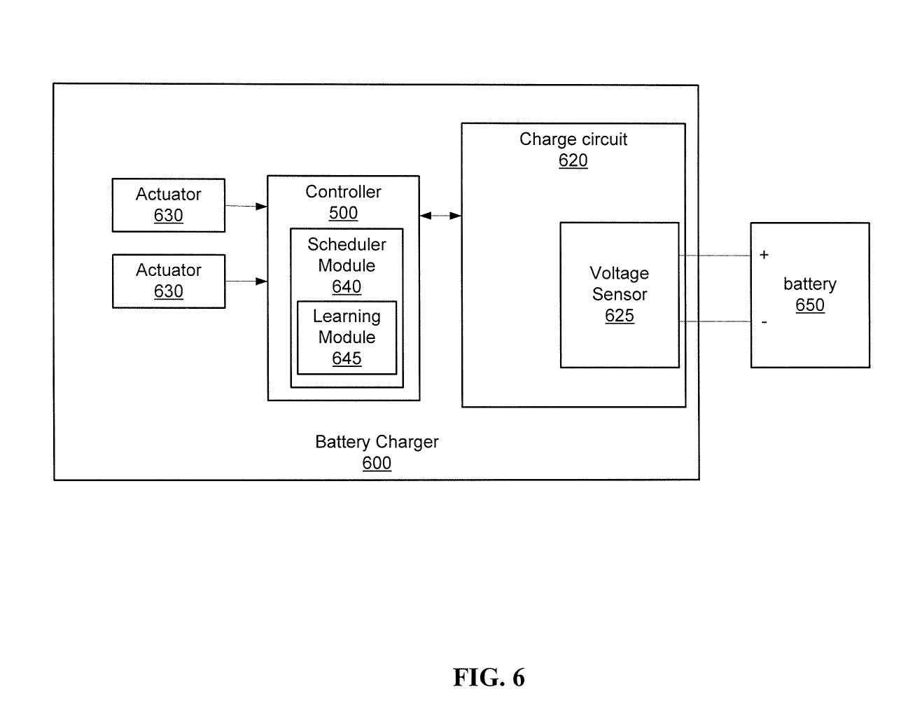

FIG. 6 is a schematic diagram illustrating an example of a battery charger 600 of the present invention. The battery charger 600 includes the controller 500 (FIG. 5), described above, in communication with a charge circuit 620. The charge circuit 620 may be controlled by the controller 500 (FIG. 5) to charge an attached battery 650 using several techniques, including, but not limited to, constant current charge and constant voltage charge, as described above. The battery 650 may have a positive terminal and a negative terminal connected to the charge circuit 620. The charge circuit contains a voltage sensor 625 to detect when a battery is attached and determine the voltage level of the battery 650.

The controller 500 may include a scheduler module 640 and a learning module 640. The scheduler module 640 may determine when the charge circuit 620 changes charging modes, for example, a low charge mode, or a top off charge mode. The learning module 645 may detect attachment and/or removal time of the battery 650, and may in turn modify a schedule in the scheduler module 640. One or more actuators in communication with the controller 500 may be used to manually override the scheduler module 640, for example, to initiate a top-off charge, to initiate or cancel occasional/vacation mode, and/or to initiate or cancel a learning mode. The actuator 630 may be a switch, a physical button, a virtual button, or other mechanism.

While FIG. 6 shows the battery 650 external to the battery charger 600, as mentioned previously, there is no objection to embodiments where the battery and battery charger are contained in a single housing, for example, within a rechargeable device. Similarly, there is no objection to the controller 500 and/or one or more actuators 630 being located remotely from the charge circuit 620.

Routine utilization of this system, without overrides, may advantageously reduce the time the battery spends in a fully charged, battery stressing state. Benefits of using this system may include allowing manufacturers to make more reasonable claims regarding battery life (hours of operation), allowing users to extend the longevity of battery powered devices, and assuring manufacturers the battery has received a reasonable amount of care affording more flexibility to warranty product.

Several embodiments of the above system are possible having controls ranging from relatively simple to more complex, including, but not limited to a charger system built into a battery powered device with only “start of day” and override buttons as user input. Another embodiment may include user defined applications allowing the user to change several settings, such as weekday and/or weekend schedules. Another possibility is a central charging system capable of managing one or more devices utilized in a system, where the utilized devices may each use different batteries with independent current and voltage level requirements. Of course, the abovementioned features may also be combined in a variety of ways.

As used within this disclosure, constant current charge refers to charging a battery by providing a constant current charge while the voltage is rising to a target voltage. The target voltage may be an optimum voltage or a maximum voltage, depending on the application.

As used within this disclosure, constant voltage charge refers to charging a battery with a constant voltage charge until the charge current has dropped to, for example, 1/20th (or equivalent) of the milli-amp hour rating of the battery, which is widely accepted as the full capacity at this voltage.

As used within this disclosure, minimum voltage refers to a minimum cell voltage for safe charging. The minimum voltage is a voltage threshold, below which a charger enters a low current charge, for example, one tenth of the normal charge current to ensure the battery remains stable.

As used within this disclosure, optimum voltage refers to a target voltage charge level of a battery below maximum voltage, typically 80% of the voltage range above the minimum voltage, or another pre-determined voltage below maximum voltage that is determined to be a voltage the battery can be charged to without stressing the battery. This may be expressed as

vₒₚₜ=(vₘₐₓ−vₘᵢₙ)*80%+vₘᵢₙ (Eq. 1).

For example, for vₘₐₓ=4.2V, vₘᵢₙ=2.9V, vₒₚₜ=(4.2−2.9)*0.8+2.9=3.94V.

As used within this disclosure, maximum voltage is a target voltage charge level of a battery per cell as defined by the manufacturer. A typical lithium ion battery is 4.2V per cell. In general, a battery charger will not exceed the maximum voltage.

As used within this disclosure, saturation refers to a state where a battery being charged by a battery charging system has reached a target voltage and the current is 1/20 of the amp hour (aH) rating of the battery. When the battery charging system is running a constant current, the voltage rises because impedance rises as the battery is being charged. Once a battery reaches the target voltage, it may not be fully charged and need to be saturated. This may be done in a subsequent constant voltage charging stage. During the constant voltage charging stage, the impedance (resistance) of the battery rises. Since I=V/R, the rising impedance will yield a drop in current. When the battery current has dropped to 1/20 of the aH rating of the battery (or a specific manufacturer specification), the battery is fully saturated. The charger will generally cease charging at this point unless it is instructed otherwise.

As used within this disclosure, override mode of a battery charging system refers to overriding traditional longevity charging techniques, and operating using normal constant current, then constant voltage charging with the target voltage at or near a maximum voltage.

As used within this disclosure, occasional/vacation mode refers to a battery charging system configured to charge a battery only to an optimum voltage level with a saturated charge and leave the battery at this level until the charge has been given a new overriding instruction other than scheduled based charging.

As used within this disclosure, top off time refers to a time period, usually measured in minutes, for a battery in a saturated state to be charged from an optimum voltage to a maximum voltage, fully saturated.

While the above descriptions and embodiments have generally referred to lithium ion batteries, there is no objection to use of batteries having other chemical structures. It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for charging a battery with a battery charger, comprising the steps of:
applying a constant current charge to said battery;
detecting a voltage level of said battery;
discontinuing applying said constant current to said battery when said voltage level substantially reaches a first threshold voltage;
automatically resuming said constant current charge to said battery; and
discontinuing applying said constant current charge to said battery when said voltage level substantially reaches a second threshold voltage.

2. The method of claim 1, further comprising the step of upon discontinuing applying said constant current charge, applying a constant voltage charge to said battery.

3. The method of claim 1, further comprising the steps of:
detecting a battery saturation level; and
discontinuing applying said constant voltage charge.

4. The method of claim 1, wherein said second threshold voltage is higher than said first threshold voltage.

5. The method of claim 1, wherein said first threshold voltage is an optimum voltage.

6. The method of claim 1, wherein said second threshold voltage is a maximum voltage.

7. The method of claim 1, wherein said applying a constant current charge to said battery is scheduled at a predetermined time.

8. The method of claim 1, further comprising the step of if said voltage level falls to a third voltage threshold, applying said constant current charge to said battery until said voltage level substantially reaches said first threshold voltage.

9. The method of claim 1, further comprising the step of detecting an override event.

10. The method of claim 9, wherein said override event comprises activation of an actuator.

11. The method of claim 9, further comprising the step of upon detecting said override event, resuming said constant current charge to said battery.

12. The method of claim 1, wherein said automatically resuming occurs at a predetermined time.

13. The method of claim 12, wherein said predetermined time is determined based on a battery usage schedule.

14. The method of claim 13, wherein said battery usage schedule is determined at least in part based on the steps of:
detecting a start time when said battery is attached to said battery charger; and
detecting an end time when said battery is removed from said battery charger.

15. A system for charging a battery comprising:
a voltage detector configured to detect a voltage level of said battery;
a battery charger configured to charge said battery, wherein said battery charger selectably charges said battery in one of the group consisting of constant current mode and constant voltage mode; and
a controller comprising a computer logic circuit in communication with said voltage detector and configured to control said battery charger according to the steps of:
activating said battery charger in constant current mode;
receiving a voltage level of said battery from said voltage detector;
deactivating said constant current mode when said voltage level substantially reaches a first threshold voltage;
automatically resuming said constant current mode; and
deactivating said constant current mode when said voltage level substantially reaches a second threshold voltage.

16. The system of claim 15, further comprising an override actuator.

17. The system of claim 15, further comprising a housing for said voltage detector, said battery charger, and said controller.

18. The system of claim 15, wherein said controller further comprises the step of upon discontinuing applying said constant current charge, applying a constant voltage charge to said battery.

19. The system of claim 15, wherein said controller further comprises steps of:
detecting a battery saturation level; and
discontinuing applying said constant voltage charge.

20. A computer readable memory configured to store non-transient instructions for controlling a battery charger system, comprising the steps of:
applying a constant current to said battery;
detecting a voltage level of said battery;
discontinuing applying said constant current to said battery when said voltage level substantially reaches a first threshold voltage;
automatically resuming said constant current to said battery; and
discontinuing applying said constant current to said battery when said voltage level substantially reaches a second threshold voltage.
